(19) United States
(12) Patent Application Publication
(10) Pub. No.: US 2010/0018605 A1
(43) Pub. Date: Jan. 28, 2010

(54) FUEL DETECTION DEVICE

(75) Inventor: Galliano Bentivoglio, Bologna (IT)

Correspondence Address: TUTUNJIAN + BITETTO, P.C., 20 CROSSWAYS PARK NORTH, SUITE 210, WOODBURY, NY, 11797, US

(73) Assignee: NOZZLE ENG. S.r.l., Bologna (IT)

(21) Appl. No.: 12/306,102

(22) PCT Filed: Jun. 20, 2007
(86) PCT No.: PCT/IB2007/052380

§ 371 Date: Jul. 29, 2009

(30) Foreign Application Priority Data
Jun. 21, 2006 (IT) MO2006A000202

(51) Int. Cl. B67D 7/46

(52) U.S. Cl. 141/198

(57) ABSTRACT

A fuel detection device, in a fuel nozzle fitted with a fuel-dispensing pipe, includes the fuel-dispensing pipe and a bushing arranged inside the dispensing pipe. The pipe and the bushing form an annular interspace and realize a condenser whose plates are the pipe itself. The bushing, and the condenser being suitable for measuring the dielectric constant in the zone of the annular interspace by measuring the capacity of the condenser and in such as way as to detect the presence of fuel in the aforesaid annular interspace, the fuel detection device uses a reference capacity measurement obtained from the value of the dielectric constant of air in the annular interspace at an instant prior to the insertion of the nozzle into the inlet of the tank of the vehicle to fill.

### TECHNICAL FIELD

The present invention relates to a fuel detection device for fuel-filling nozzles and, in particular, the present device, applicable to nozzles for filling fuels, is envisaged for detecting the presence of fuel when, during filling of a vehicle tank, filling of the tank is almost complete and it is therefore necessary to stop dispensing in order to prevent fuel spillage outside the tank.

The device according to the present invention detects the presence of fuel returning from the tank inlet of the vehicle being filled and provides a signal directly to the fuel-dispensing valve in such a way as to stop dispensing fuel, or to a control unit of the nozzle that uses this signal to close the fuel-dispensing valve.

### PRIOR ART

Fuel detection devices of known type are mainly based on a pressure sensor, also known as an overfill sensor, that detects the pressure variations in a small pipe that is parallel to and generally integrated in the dispensing pipe of the nozzle.

The presence of fuel near the end of a dispensing pipe is therefore detected by means of the increase in pressure in the tank inlet. The increase in pressure, due to the fuel column returning from the vehicle's tank, is therefore also transmitted to the pipe parallel to the dispensing pipe of the nozzle, providing a pressure increase signal to the sensor. The closure of the fuel-dispensing valve is therefore commanded by this signal.

The operation of these devices based on pressure measurement is often unsatisfactory: sometimes dispensing the fuel is stopped too soon, for example because of foam that can form from the fuel, so that it is not possible to completely fill the vehicle's tank; other times stopping is not sufficiently prompt and therefore fuel continues to be dispensed when the tank is full thus spilling from it.

In order to improve the prompt interruption of the fuel dispensing, other fuel detection devices, which are based on operating principles that differ from that of pressure measurement have been proposed.

An electronic device for controlling the dispensing of a fluid in a tank, that uses a sensor located in the fuel-dispensing pipe towards the tank, is disclosed in U.S. Pat. No. 3,814,146.

The sensor is energized electronically in such a way as to vibrate at its own natural frequency, the sensor vibrations being therefore used for generating an electrical signal proportional to the frequency. The signal generated by the sensor is sent to a response circuit that opens the dispensing valve, or keeps it open, thereby making it possible to dispense the fluid as long as the sensor vibration frequency remains unchanged.

When the level of the fluid in the tank rises, the sensor vibration frequency changes following contact with the fluid and, as a consequence, a signal is sent to close the fuel-dispensing valve.

U.S. Pat. No. 2,918,095 describes another sensor of the electronic type, located at the end of the fuel-dispensing pipe, based on the measurement of the dielectric constant in an annular interspace formed by the delivery pipe of the fuel itself and by a pipe coaxial with and external to the fuel delivery pipe. Measurement of the dielectric constant of the interspace is carried out by considering the two pipes as the plates of a condenser.

The abovementioned condenser is inserted into a resonating electronic circuit and the condenser's capacity is variable depending on the dielectric found or that can be inserted into the interspace between the two pipes.

For example, when the fuel rises from the tank and reaches the interspace between the two pipes, the condenser's capacity increases and reaches a critical value that interrupts fuel dispensing.

The fuel detector devices according to the aforesaid patents have never been applied practically in fuel nozzles. For these devices too, operation has been found to be unsatisfactory because they were not sufficiently prompt in detecting the variations of the magnitude measured, frequency or dielectric constant.

In particular, these devices are not sufficiently prompt in detecting the threshold value at which to stop dispensing fuel. Furthermore, as these devices are based on measurements of the electric type, they were not easy to integrate in the fuel-dispensing nozzles of the period which were exclusively of the mechanical type. The power supply necessary for operating the sensors was absent and there were also many difficulties in realizing the closure of the fuel-dispensing valve which was of the purely mechanical type

### DISCLOSURE OF THE INVENTION

It is an object of the present invention therefore to improve the known fuel detection devices.

Another object of the invention is to provide a fuel detection device whose operation is safe and reliable.

Another object of the invention is to provide a fuel detection device that can be integrated in an optimum manner with fuel-dispensing nozzles, in particular with electromagnetically operated fuel-dispensing nozzles.

Yet another object of the invention is to provide a fuel detection device that is explosion-proof.

A further object of the present invention is to provide a fuel detection device that is simple and economical to manufacture.

According to one aspect of the present invention, a fuel detection device is provided in a fuel nozzle fitted with a fuel-dispensing pipe, the device comprising the said fuel-dispensing pipe and a bushing arranged inside the dispensing pipe, the said pipe and the said bushing forming an annular interspace and realizing a condenser whose plates are the pipe itself and the bushing, the said condenser being suitable for measuring the dielectric constant in the zone of annular interspace by measuring the capacity of the said condenser and in such as way as to detect the presence of fuel in the aforesaid annular interspace, characterized in that the said fuel detection device uses a reference capacity measurement obtained from the value of the dielectric constant of the air in the annular interspace at an instant prior to the insertion of the nozzle into the inlet of the tank of the vehicle to fill.

As a result of the invention, the fuel detection device is able to promptly detect the presence of fuel as the reference measurement of the air's dielectric constant is made at an instant prior to insertion of the nozzle into the tank inlet and takes account of the variables that could change the aforesaid value of the dielectric constant of the air at that instant, such as humidity, temperature, dust, etcetera.

It is therefore possible, by way of this reference measurement, to relate in a very precise manner the corresponding threshold value to the presence of fuel in the fuel detection device.

The dependent claims refer to preferred and advantageous embodiments of the invention.

### BRIEF DESCRIPTION OF THE DRAWINGS

Further objects and advantages of the present invention will be made clearer by the following detailed description of some preferred embodiments of the present invention, provided with reference to the attached drawings, in which:

FIG. 1 is a lateral view, with parts in section, of a nozzle for dispensing fuel, equipped with a fuel detection device according to the present invention; and

FIG. 2 is an enlarged, and view sectional, of some details of the fuel detection device applied to the nozzle in FIG. 1.

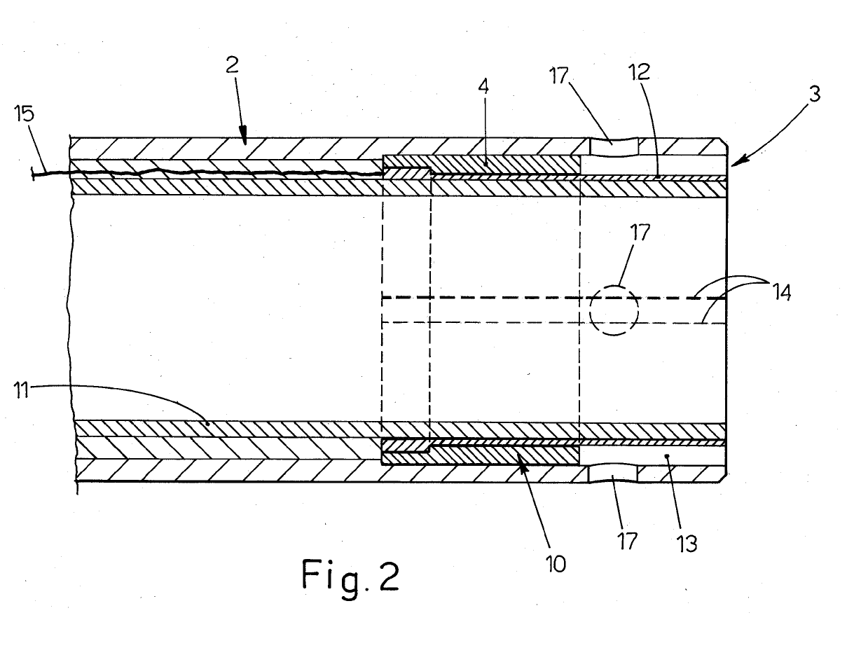

### EMBODIMENTS OF THE INVENTION

With reference to the attached drawings, a fuel-dispensing nozzle is indicated as a whole by 1. The nozzle 1 comprises a fuel-dispensing pipe 2 having an end 3 suitable for being inserted into a vehicle's tank (not illustrated), while a fuel detection device 10 according to the present invention is also provided at the end 3.

The fuel detection device 10 is at the end 3 of the dispensing pipe 2, and essentially comprises the pipe 2 itself and a bushing 12 fitted on an internal pipe 11; the internal pipe 11 has a slightly smaller diameter than the internal diameter of the pipe 2, and is coaxial with the said pipe 2.

The thickness of the bushing 12 is small and it is made of metal, of brass for example, or of another electrically conductive material. The bushing 12 also has a slightly smaller external diameter than the internal diameter of the pipe 2 and in order to facilitate the insertion of the bushing 12 on the internal pipe 11, the said bushing 12 can have a longitudinal notch 14.

The bushing 12 therefore forms an annular interspace with the dispensing pipe 2 at the end 3 and inside the pipe 2; the bushing 12 is maintained coaxial to the pipe 2 by means of a spacer ring 4 which also closes the bottom of the interspace 13. The internal pipe 11 is in turn connected to a fuel-dispensing valve (not illustrated) for dispensing a flow of fuel into a vehicle's tank (not illustrated). The internal pipe 11 can be made of a fuel-proof plastic material and, being inside the bushing 12, it is also in a coaxial position with respect to the dispensing pipe 2. At least one bleed hole 17 close to the bottom of the interspace 13 can be provided on the pipe 2 and, more in general, some bleed holes 17 are envisaged to permit the escape of air when the said interspace 13 is struck by the fuel rising from the vehicle's tank being filled.

The internal pipe 11 can be made of polyamide, for example Rilsan, a registered trademark of Arkema, while the dispensing pipe 2 can be made of any metal suitable for contact with fuel. For example, the pipe 2 can be made of stainless steel, brass, etcetera.

The device 10 according to the present invention is also highly explosion-proof as it is connected to the fuel-dispensing valve or, if there is one, to the control unit of the dispensing valve, by means of two resistances in series. The aforesaid resistances in series make the device 10 intrinsically explosion-proof and have no effect on the measurement of the capacity.

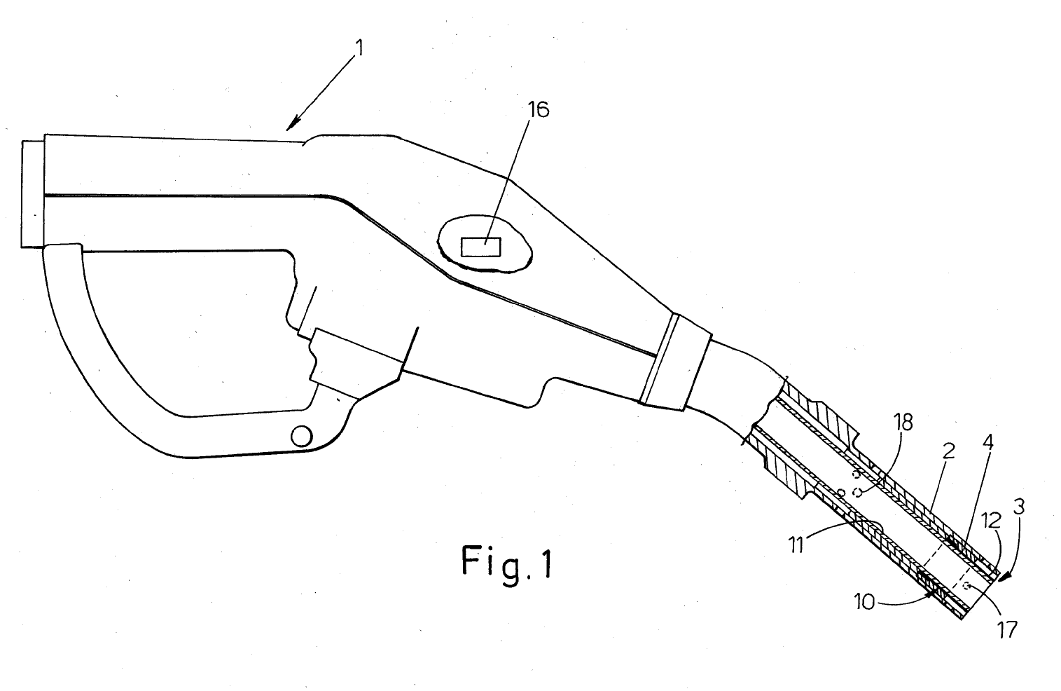

According to FIG. 1, the pipe 2 can also have some extraction holes 18 in communication with an internal pipe (not illustrated) connected to a fuel-vapour extraction circuit; the first part of this pipe can be in annular shape and formed by the pipe 2 and by the internal pipe 11.

The bushing 12 and the dispensing pipe 2 constitute the plates of a condenser that is used by the fuel detection device 10 to measure the dielectric constant of the zone that is in the interspace 13. The bushing 12 is also connected, by means of a signal transmission wire 15, directly to the fuel-dispensing valve (not illustrated) or possibly to a control unit (not illustrated) of the nozzle 1.

The nozzle 1 also comprises an inclination sensor 16, of a known type, which is also connected to the fuel-dispensing valve, or to the nozzle control unit and provides the enabling signal for dispensing the fuel when the body of the nozzle 1 is in a virtually horizontal position, namely the position that normally corresponds to the position of insertion of the nozzle into the inlet of the vehicle's tank. In this case, this enabling the dispensing by the sensor 16 is also used for determining the moment to measure the dielectric constant of the zone in the interspace 13.

The inclination sensor 16 is therefore also part of the detection device 10, as it makes it possible to easily determine the instant that precedes the insertion of the nozzle 1 into the inlet of the tank to fill and because it is usually already present in fuel nozzles.

Naturally, other devices can be used which are capable of detecting when the nozzle 1 is nearing the inlet of the tank, for example a proximity sensor, or a timer which defines a certain delay time from the moment in which the nozzle is detached from the supply column, in order to take the reference measurement of the dielectric constant of the air.

During dispensing of the fuel, while filling of the vehicle's tank is almost complete, the zone in the annular interspace 13 can be struck by the fuel itself returning from the tank.

By continuously measuring the condenser capacity and comparing the measured value with the value of a reference capacity measured when the interspace 13 is filled with air only, it is possible to check the variation of the dielectric constant in the zone of the interspace 13, and therefore it is possible to rapidly check the presence of the fuel itself close to the end 3 of the dispensing pipe 2.

An important characteristic of the fuel detection device 10 according to the present invention is the measurement of the value of the reference dielectric constant, i.e. when the end of the nozzle is not in contact with the fuel, in accordance with what will be described in greater detail below.

The user extracts the nozzle 1 from its seat in the supply column and positions the body of the nozzle 1 horizontally in such a way as to insert the dispensing pipe 2 into the inlet of the tank to fill.

The inclination sensor 16 then provides the signal to enable dispensing of the fuel. At this instant, i.e. when the inclination sensor 16 enables dispensing of the fuel, this instant being immediately prior to the insertion of the nozzle into the inlet of the tank of the vehicle to fill, a measurement is made of the value of the dielectric constant of the air in the annular interspace 13. The abovementioned measurement serves as a reference for the subsequent detection of fuel. As already said above, as an alternative to the inclination sensor 16, other means can be used for providing the enabling signal for measuring the value of the dielectric constant of the air in the annular interspace 13.

Naturally, the measurement of the dielectric constant is carried out in an indirect manner by measuring the capacity of the condenser consisting of the pipe 2, the bushing 12 and the interspace 13.

The measurement of the value of the dielectric constant of the air in the interspace 13, immediately prior to filling, takes account in this way of all the variables that could change the aforesaid value of the dielectric constant of the air at that instant, such as humidity, temperature, dust, etcetera.

During refueling, the value of the dielectric constant in the zone inside the interspace 13 is measured continuously and this value is compared with the reference value obtained before starting refueling.

When, in the interspace 13, the difference between the reference value and the current value of the dielectric constant exceeds a certain threshold value corresponding to the presence of fuel, the device 10 sends a signal to stop the flow of fuel to the fuel-dispensing valve or, if there is one, to the control unit of the dispensing valve.

The fuel detection device 10 according to the present invention integrates well with fuel nozzles fitted with electromechanically operated dispensing valves, as the wiring and power supply required for the device 10 are already present.

However, the device 10 according to the present invention can also equally be applied to nozzles with completely mechanical dispensing valves, by providing the said valves with appropriate electromechanical stopping devices.

Furthermore, different versions of the fuel detection device 10 are also possible, again based on the measurement of the dielectric constant in the zone of the interspace 13, but with different arrangements of the construction elements.

As a whole, the fuel detection device according to the present invention is much more prompt than the known devices, generally based on pressure measurement.

Naturally, the present invention is not limited to the executive embodiments illustrated and described, but also includes all the appropriate variants and modifications for achieving the same result and, therefore, falling within the vaster scope of the inventive concept, substantially as described, illustrated and as claimed.

In the claims, the references provided between parentheses are purely indicative and do not limit the scope of protection of the claims.

1-11. (canceled)

12. Fuel detection device (10), in a fuel nozzle (1) fitted with a fuel-dispensing pipe (2), the device (10) comprising the fuel-dispensing pipe (2) and a bushing (12) arranged inside the dispensing pipe (2), the pipe (2) and the bushing (12) forming an annular interspace (13) and realizing a condenser whose plates are the pipe itself (2) and the bushing (12), the condenser being suitable for measuring the dielectric constant in the zone of the annular interspace (13) by measuring the capacity of the condenser and in such as way as to detect the presence of fuel in the annular interspace (13), wherein die fuel detection device (10) uses a reference capacity measurement obtained from the value of the dielectric constant of air in the annular interspace (13) at an instant prior to the insertion of the nozzle (1) into the inlet of the tank of the vehicle to fill.

13. Fuel detection device according to claim 1, in which the bushing (12) is fitted on an internal pipe (11) that dispenses the fuel for filling.

14. Fuel detection device according to claim 1, in which the fuel-dispensing pipe (2) is made of an electrically conductive material, and the bushing (12) is also made of another electrically conductive material.

15. Fuel detection device according to claim 1, in which the internal pipe (11) is made of a plastic material.

16. Fuel detection device according to claim 1, in which die bushing (12) is maintained coaxially to the pipe (2) by means of a spacer ring (4) which also closes the bottom of the interspace (13).

17. Fuel detection device according to claim 1, in which the fuel-dispensing pipe (2) is provided with at least one bleed hole (17) to permit the escape of air in the interspace (13), when the interspace (13) is struck by the fuel.

18. Fuel detection device according to claim 1, in which the bushing (12) is connected, by means of a signal transmission wire (15), to one of the fuel-dispensing valve and a control unit of the nozzle (1).

19. Fuel detection device according to claim 1 in which the detection device (10) is connected to the fuel-dispensing valve or, if there is one, to the control unit of the dispensing valve, by means of two resistances in series.

20. Fuel detection device according to claim 1, comprising means (16) for enabling measurement of the value of the dielectric constant of the air which is in the annular interspace (13) at an instant prior to the insertion of the nozzle into the inlet of the tank to fill.

21. Fuel detection device according to claim 20, in which the means for enabling measurement of the value of the dielectric constant of the air comprises an inclination sensor (16) suitable for providing a signal when the body of the nozzle (1) is in a position corresponding to the position of insertion of the nozzle into the inlet of the tank to fill.

22. Fuel detection device according to claim 1, in which the detection device (10) is connected to an electromechanically operated fuel-dispensing valve.
